(19) United States
(12) Patent Application Publication
(10) Pub. No.: US 2026/0081186 A1
(43) Pub. Date: Mar. 19, 2026

(54) ONE FURNACE SINTERING AND OXIDATION METHOD FOR ELECTROCHEMICAL CELL STACK INTERCONNECTS

(71) Applicant: BLOOM ENERGY CORPORATION, San Jose, CA (US)

(72) Inventor: Chad FOLKMAN, San Jose, CA (US)

(21) Appl. No.: 19/313,049

(22) Filed: Aug. 28, 2025

Related U.S. Application Data
(60) Provisional application No. 63/695,106, filed on Sep. 16, 2024.

(51) Int. Cl. H01M 8/0208; C25B 1/04; C25B 9/65

(52) U.S. Cl. CPC H01M 8/0208; C25B 9/65; C25B 1/04

(57) ABSTRACT

A method includes placing an interconnect in a furnace, sintering the interconnect by heating the interconnect in a reducing atmosphere in the furnace, oxidizing the interconnect by heating the interconnect in an oxidizing atmosphere in the furnace, and removing interconnect from the furnace.

### FIELD

The embodiments of the present disclosure are generally directed to interconnects for electrochemical cell stacks, and more specifically to an interconnect sintering and oxidation method carried out in the same furnace.

### BACKGROUND

In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be a hydrocarbon fuel, such as methane, natural gas, pentane, ethanol, or methanol, or a non-hydrocarbon fuel, such as ammonia or pure hydrogen. The fuel cell, operating at a typical temperature between 750° C. and 950° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between the anode and cathode, resulting in an electrical current flow through the circuit.

Fuel cell stacks may be either internally or externally manifolded for fuel and air. In internally manifolded stacks, the fuel and/or air are distributed to each cell using risers contained within the stack. In other words, gases flow through openings or holes in the supporting layer of each fuel cell, such as the electrolyte layer, and gas flow separators (e.g., interconnects) of each cell. In externally manifolded stacks, the stack is open on the fuel and air inlet and outlet sides, and the fuel and air are introduced and collected independently of the stack hardware.

Fuel cell stacks are frequently built from a multiplicity of cells in the form of planar elements, tubes, or other geometries. Fuel and air have to be provided to electrochemically active surfaces, which can be large. Fuel cell stacks include interconnects that separate the individual cells in the stack. The interconnects each separate fuel, such as hydrogen or a hydrocarbon fuel, flowing to the fuel electrode (e.g., anode) of one cell in the stack from oxidant, such as air, flowing to the air electrode (e.g., cathode) of an adjacent cell in the stack. The interconnects also electrically connect the fuel electrode of one cell to the air electrode of the adjacent cell.

### SUMMARY

According to various embodiments of the present disclosure, a method includes placing an interconnect in a furnace, sintering the interconnect by heating the interconnect in a reducing atmosphere in the furnace, oxidizing the interconnect by heating the interconnect in an oxidizing atmosphere in the furnace, and removing interconnect from the furnace.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1A is a perspective view of a fuel cell column, FIG. 1B is a perspective view of one electrochemical cell stack included in the column of FIG. 1A, and FIG. 1C is a side cross-sectional view of a portion of the stack of FIG. 1B.

FIG. 2A is a top view of the air side of an interconnect of the stack of FIG. 1B, and FIG. 2B is a top view of the fuel side of the interconnect of FIG. 2A.

FIG. 3A is a flow chart illustrating an interconnect sintering and oxidation method according to various embodiments of the present disclosure, and FIG. 3B is a chart showing process parameters during the method of FIG. 3A.

FIG. 4 is a schematic view showing the use of a continuous furnace, according to various embodiments of the present disclosure.

### DETAILED DESCRIPTION

The present disclosure is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Electrochemical cell systems include fuel cell and electrolyzer cell systems. In an electrolyzer system, such as a solid oxide electrolyzer system (SOEC), water (e.g., steam) is separated into hydrogen and oxygen by applying a voltage across the electrolyzer cells. In the SOEC stack, the anode is the air electrode, and the cathode is the fuel electrode. For both types of electrochemical cell systems, the electrode to which the fuel (e.g., hydrogen or hydrocarbon fuel in a SOFC, and water in a SOEC) is supplied may be referred to as the fuel electrode and the opposing electrode may be referred to as the air electrode.

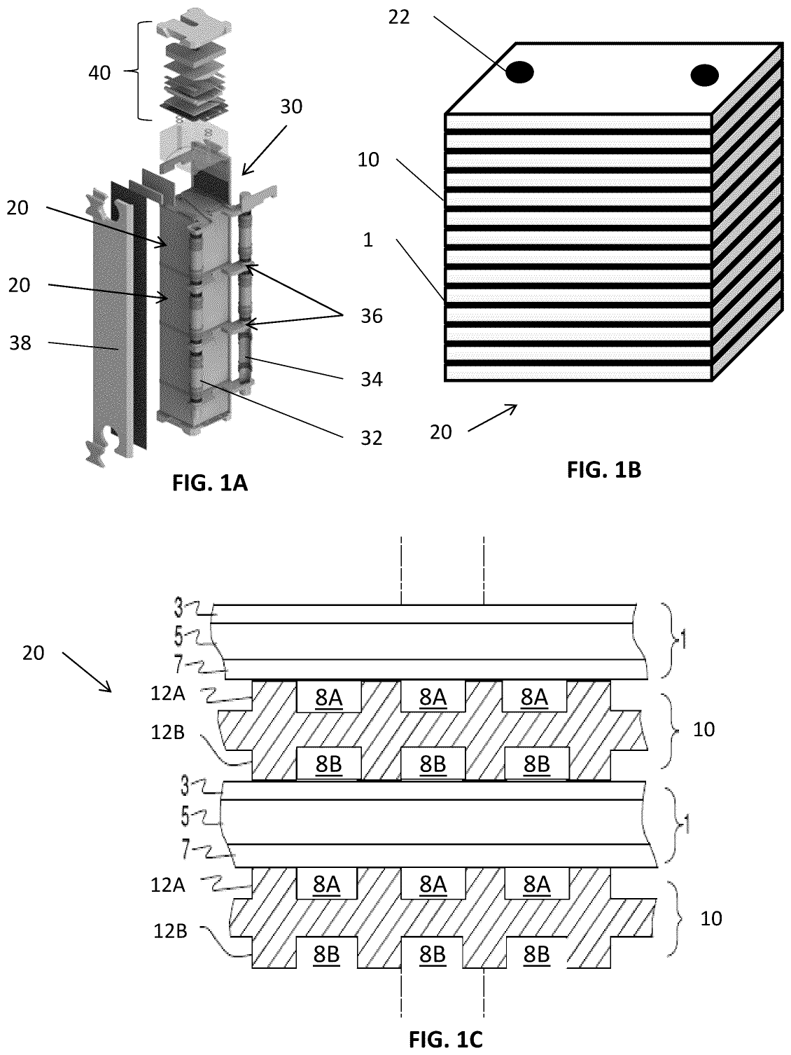

FIG. 1A is a perspective view of an exemplary electrochemical cell column 30, FIG. 1B is a perspective view of one counter-flow electrochemical cell stack 20 included in the column 30 of FIG. 1A, and FIG. 1C is a side cross-sectional view of a portion of the stack 20 of FIG. 1B.

Referring to FIGS. 1A and 1B, the column 30 may include one or more electrochemical cell stacks 20, a fuel inlet conduit 32, a fuel exhaust conduit 34, and fuel feed/return assemblies 36 (e.g., anode splitter plates (ASPs) 36). The column 30 may also include side baffles 38 and a compression assembly 40. The fuel inlet conduit 32 is fluidly connected to ASPs 36 and is configured to provide the fuel feed to each ASP 36, and fuel exhaust conduit 34 is fluidly connected to ASPs 36 and is configured to receive fuel exhaust from each ASP 36.

The ASPs 36 are disposed between the stacks 20 and are configured to provide a hydrocarbon fuel or a hydrogen containing fuel feed to the stacks 20 and to receive fuel exhaust from the stacks 20. For example, the ASPs 36 may be fluidly connected to internal fuel riser channels 22 formed in the stacks 20, as discussed below.

Referring to FIG. 1C, the stack 20 includes multiple electrochemical cells (e.g., SOFCs or SOECs) 1 that are separated by interconnects 10, which may also be referred to as gas flow separator plates or bipolar plates. Each electrochemical cell 1 includes an air electrode (e.g., cathode electrode for a SOFC) 3, a solid oxide electrolyte 5, and a fuel electrode (e.g., anode electrode for a SOFC) 7.

Each interconnect 10 electrically connects adjacent electrochemical cells 1 in the stack 20. In particular, an interconnect 10 may electrically connect the fuel electrode 7 of one electrochemical cell 1 to the air electrode 3 of an adjacent electrochemical cell 1. FIG. 1C shows that the lower electrochemical cell 1 is located between two interconnects 10.

Each interconnect 10 includes ribs 12A, 12B that at least partially define fuel channels 8A and air channels 8B. The interconnect 10 may operate as a gas-fuel separator that separates a fuel flowing to the fuel electrode 7 of one cell in the stack from oxidant, such as air, flowing to the air electrode 3 of an adjacent cell in the stack. At either end of the stack 20, there may be an air end plate or fuel end plate (not shown) for providing air or fuel, respectively, to the end electrode in the stack. Alternatively, end plates of the stacks may comprise the same interconnect design used throughout the stack.

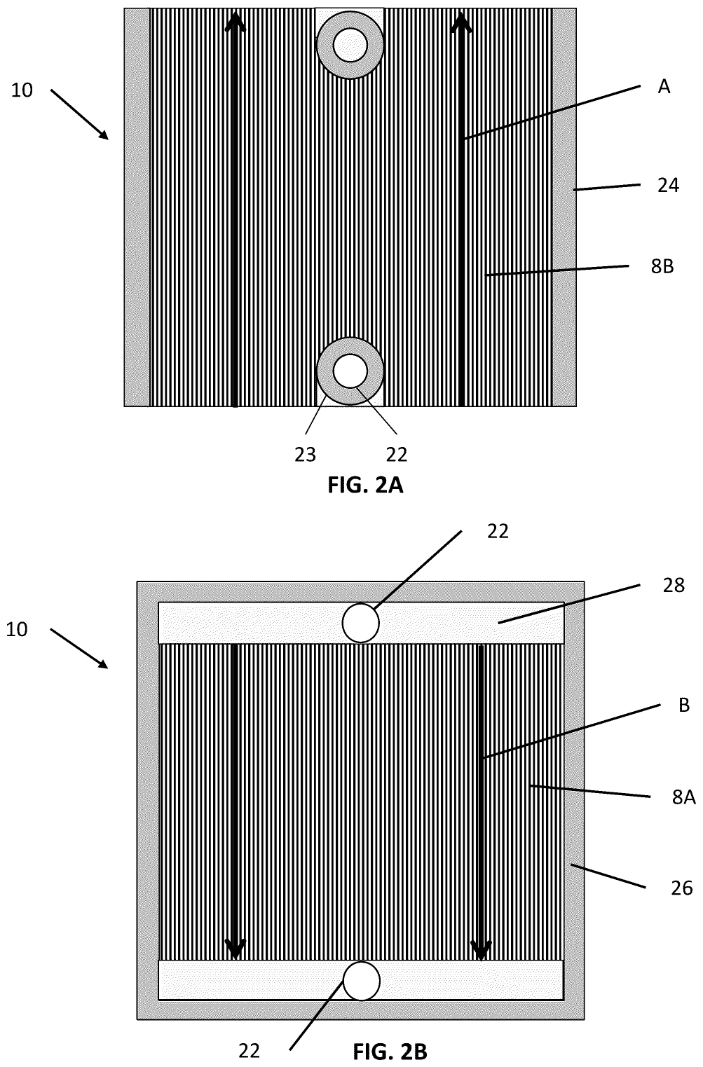

FIG. 2A is a top view of the air side of the interconnect 10, and FIG. 2B is a top view of a fuel side of the interconnect 10. Referring to FIGS. 1C and 2A, the air side includes the air channels 8B. Air flows through the air channels 8B to the air electrode 3 of an adjacent electrochemical cell 1. In particular, the air may flow across the interconnect 10 in a first direction A as indicated by the arrows.

Ring seals 23 may surround fuel holes 22 of the interconnect 10, to prevent fuel from contacting the air electrode. Peripheral strip-shaped seals 24 are located on peripheral portions of the air side of the interconnect 10. The seals 23, 24 may be formed of a glass material. The peripheral portions may be in the form of an elevated plateau which does not include ribs or channels. The surface of the peripheral regions may be coplanar with tops of the air ribs 12B.

Referring to FIGS. 1C and 2B, the fuel side of the interconnect 10 may include the fuel channels 8A and fuel manifolds 28 (e.g., fuel plenums). Fuel flows from one of the fuel holes 22, into the adjacent manifold 28, through the fuel channels 8A, and to a fuel electrode 7 of an adjacent cell 1. Excess fuel may flow into the other fuel manifold 28 and then into the adjacent fuel hole 22. In particular, the fuel may flow across the interconnect 10 in a second direction B, as indicated by the arrows. The second direction B may be opposite to the first direction A (see FIG. 2A) referred to as a counter-flow design, perpendicular to the first direction A referred to as a cross-flow design (discussed below), or in the same direction as first direction A referred to as co-flow design.

A frame-shaped seal 26 is disposed on a peripheral region of the fuel side of the interconnect 10. The peripheral region may be an elevated plateau which does not include ribs or channels. The surface of the peripheral region may be coplanar with tops of the fuel ribs 12B.

The interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnect 10 may comprise a metal (e.g., a chromium-iron alloy, such as 4-6 weight percent iron, optionally 1 or less weight percent yttrium and balance chromium alloy) and may electrically connect the fuel side of one electrochemical cell to the air side of an adjacent electrochemical cell. An electrically conductive contact layer, such as a nickel contact layer (e.g., a nickel mesh), may be provided between the fuel electrode and each interconnect 10. Another optional electrically conductive contact layer may be provided between the air electrodes and each interconnect 10.

A surface of an interconnect 10 that in operation is exposed to an oxidizing environment (e.g., air), such as the air side facing side of the interconnect 10, may be coated with a protective coating layer in order to decrease the growth rate of a chromium oxide surface layer on the interconnect and to suppress evaporation of chromium vapor species which can poison the fuel electrode of the cell. Typically, the coating layer, which can comprise a perovskite such as lanthanum strontium manganite (LSM), may be formed using a spray coating or dip coating process. Alternatively, other metal oxide coatings, such as a spinel, such as an (Mn, Co)₃O₄ spinel (MCO), can be used instead of or in addition to LSM. Any spinel having the composition Mn₂₋ₓCo₁₊ₓO₄ (0≤x≤1) or written as z(Mn₃O₄)+(1−z)(Co₃O₄), where (⅓≤z≤⅔) or written as (Mn, Co)₃O₄ may be used. In other embodiments, a mixed layer of LSM and MCO, or a stack of LSM and MCO layers may be used as the coating layer.

While a co-flow or counter-flow interconnect 10 is illustrated in FIGS. 1A-1C, in alternative embodiments, the interconnect 10 may comprise a crossflow interconnect in which the air and fuel channels extend perpendicular to each other, as described in U.S. Pat. No. 11,355,762 B2, which is incorporated herein by reference in its entirety.

According to various embodiments, interconnects may be manufactured by a powder metallurgy (PM) process followed by a sintering (i.e., a high temperature densification) process. In particular, a green body interconnect may be manufactured by pressing a metal powder at a high pressure. For example, the metal powder may comprise 4-6 weight percent iron, optionally 1 or less weight percent yttrium, and a balance of chromium. An optional lubricant and/or binder may also be added to the metal powder to facilitate compaction. Suitable lubricants include metallic stearates, such as zinc stearate and lithium stearate, amide waxes, such as ethylene bis-stearamide, or a combination thereof.

The PM green body interconnect may include mechanically locked metal and lubricant particles. For example, the green body interconnect may have an average particle size ranging from about 20 μm to about 300 μm. However, a green body interconnect may lack a mechanical strength sufficient for use in an electrochemical cell stack, due to the lack of chemical and/or material bonding between the metal particles. In addition, the density of the green body interconnect may be relatively low, due to chromium being resistant to compaction due to its high inherent hardness. Therefore, the PM green body interconnect may be subjected to an optional de-binding (i.e., dewaxing) anneal step at a relatively low temperature to evaporate the binder and/or lubricant from the PM green body interconnect. The debindered PM green body interconnect is sintered at a relatively high temperature (e.g., at least 800° C.) which is higher than the de-binding anneal temperature, to provide chemical and/or material bonds between the metal particles. Specifically, the metal particles may be sintered together, such that metal atoms diffuse across particle boundaries and fuse the particles together to form a solid interconnect. Alternatively, a separate de-binding anneal may be omitted, and the binder and/or lubricant is evaporated during the sintering process (e.g., during an initial dewaxing stage of the sintering process).

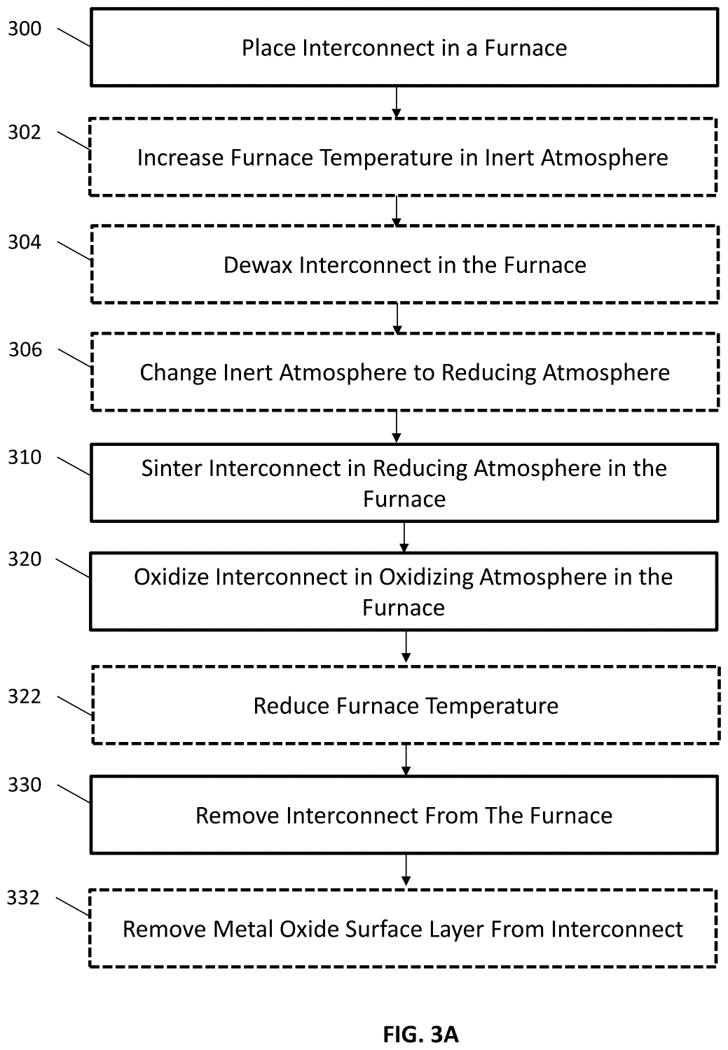

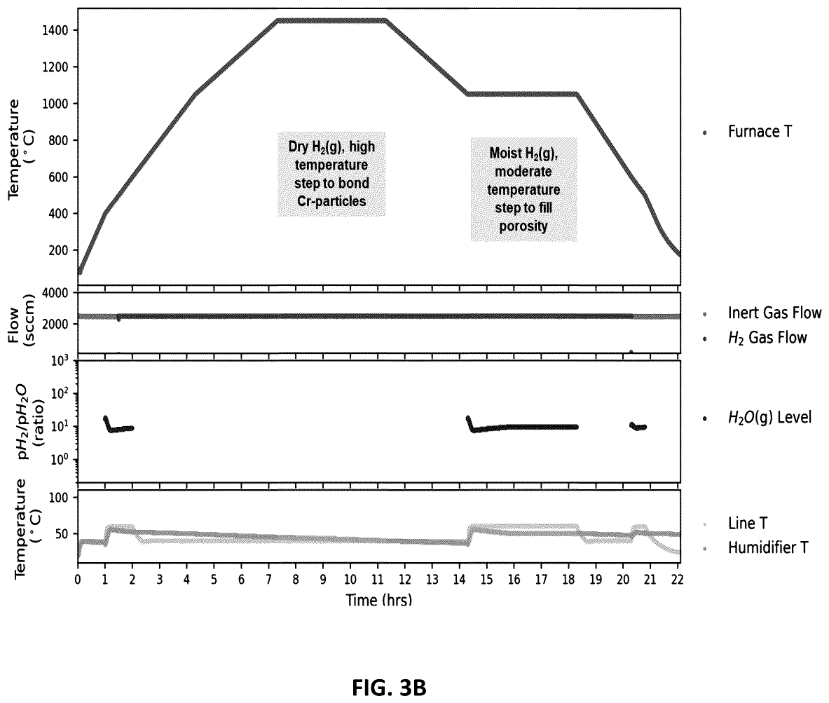

FIG. 3A is a flow chart illustrating a sintering and oxidation method, according to various embodiments of the present disclosure, and FIG. 3B is a graph showing furnace conditions during the method of FIG. 3A. Referring to FIGS. 3A and 3B, in step 300, the method may include inserting one or more PM green body interconnects into a furnace. As described below, the furnace may be a batch furnace. However, in other embodiments, the furnace may be a continuous furnace. The batch furnace may initially be at ambient temperature (e.g., about 20° C.). In step 300, the PM green body interconnect (which may optionally be debindered) is placed in the furnace.

In step 302, the furnace temperature may be increased from about ambient temperature to a first temperature of at least 1300° C., such as a temperature ranging from about 1350° C. to about 1550° C., such as from about 1400° C. to about 1500° C., or about 1450° C. In some embodiments, the temperature of the furnace may be increased at a rate of from about 150° C./hour to about 300° C./hour, such as about 200° C./hour. However, any suitable temperature ramp up rate may be used.

Optionally, during step 302, the furnace may be continuously supplied with an inert gas, such as nitrogen or argon. The inert gas flow rate may be between 1500 and 3500 sccm, such as from 2000 sccm to 3000 sccm. However, any other suitable flow rate may be used. The inert gas may be supplied for 30 to 120 minutes, such as 60 to 90 minutes. The inert gas may be used to increase the safety of the process.

If the PM green body interconnect has not been de-bindered before being placed into the furnace, then in optional step 304, the PM green body interconnect is dewaxed (i.e., debindered) in the furnace while the furnace temperature is being increased to the sintering temperature. During step 304, the organic binder and/or lubricant is burned out of the PM green body interconnect.

In step 306, once the furnace reaches a temperature of at least 400° C., such as a temperature ranging from 400° C. to 600° C., or about 500° C., the furnace may be supplied with a reducing gas. The inert gas flow may be continued or terminated once the flow of the reducing gas flow is initiated. In various embodiments, the reducing gas may be hydrogen (H₂). However, any other suitable reducing gas, such as ammonia or carbon monoxide may be used. In one embodiment, the flow of the inert gas is terminated and the flow of the reducing gas is initiated. In an alternative embodiment, if a nitrogen inert gas flow is continued after initiation of the reducing gas flow, then the furnace ambient includes a combination of nitrogen and hydrogen (i.e., forming gas). The reducing gas may be supplied at a flow rate ranging from 1500 sccm to 3500 sccm, such as from 2000 sccm to 3000 sccm. However, any suitable flow rates may be used.

Optionally, during step 306, water vapor may be provided into the furnace during initiation of the reducing gas flow into the furnace. For example, water vapor flow may be provided during the switch over from inert gas to reducing gas. In one embodiment, the reducing gas (e.g., hydrogen gas) may be flowed through a humidifier to introduce water vapor into the furnace. The humidifier may be located outside the interior volume of the furnace in which the interconnect is located. The humidifier may be fluidly connected to the interior volume of the furnace by a humidifier line (e.g., pipe or manifold). The humidifier line may be heated to a temperature slightly higher (e.g., 5 to 20° C. higher) than the humidifier temperature to avoid condensation in the humidifier line. The humidified reducing gas (e.g., a hydrogen and water vapor containing stream) is then provided from the humidifier through the humidifier line into the interior volume of the furnace to form a humidified atmosphere in the interior volume of the furnace.

The humidifier temperature and the humidifier line temperature may be increased from a temperature below 50° C. (e.g., between 25 and 40° C.) to a temperature above 50° C., such as a temperature ranging from 55° C. to 70° C. when water vapor is provided into the furnace. For example, water vapor may be provided into the furnace for a first period ranging from 30 minutes to 120 minutes, such as 45 to 90 minutes, for example 50 to 70 minutes, during which period the reducing gas flow into the furnace is initiated. The furnace temperature may range from 400° C. to 600° C. during the first period. The water vapor flow into the furnace may be terminated after the first period. For example, the flow of the water vapor into the furnace may begin 1 to 60 minutes prior to the switch over from inert to reducing atmosphere in the furnace, and may continue for 1 to 60 minutes after the switch over from the inert atmosphere to the reducing atmosphere in the furnace. A ratio of reducing gas (e.g., hydrogen) partial pressure to water vapor partial pressure in the humidified atmosphere in the furnace during the first period may range from 5 to 30, such as from 8 to 20, for example, from 9 to 11, or about 10. Alternatively, water vapor provision into the furnace during the first period in step 306 may be omitted.

After the first period in step 306, the water vapor flow into the furnace may be terminated and the humidifier temperature and the humidifier line temperature may be reduced to below 50° C. (e.g., between 25 and 40° C.). The furnace temperature is increased from above 600° C. to the first temperature of at least 1300° C. During this period, no water vapor is flowed into the furnace.

In step 310, the interconnect is sintered in a reducing atmosphere. As used herein, a “reducing atmosphere” comprises an atmosphere at which the metal form of the interconnect rather than the metal oxide form of the interconnect is stable at the sintering temperature. For example, the sintering temperature may be 700° C. to 1600° C., such as 1350° C. to 1550° C. for interconnects that comprise a chromium based alloy, such as chromium containing 4 to 6 weight percent iron. Below 700° C., the sintering reaction kinetics are slow, which leads to an undesirable increase in sintering time. Above 1600° C., chromium begins to evaporate from the interconnect. Chromium metal is stable at the above sintering temperatures even in atmospheres which contain a small amount of oxidant, such as water vapor, oxygen or carbon dioxide. Therefore, as used herein, the term reducing atmosphere includes a pure reducing atmosphere, an atmosphere containing some oxidant in a reducing gas, or a vacuum atmosphere. Therefore, if the furnace comprises a vacuum furnace, then the reducing atmosphere may comprise a vacuum atmosphere because chromium metal (or Cr—Fe metal alloy) is stable in the vacuum in the sintering temperature range.

In one embodiment, in step 310, the furnace may be held at the first temperature (e.g., about 1450° C.) for a time period sufficient to sinter the interconnect, while a dry reducing atmosphere is maintained within the furnace. The dry reducing atmosphere may have a relative humidity ranging from 0 to 1%. For example, the dry reducing atmosphere may have a pH₂/pH₂O ratio greater than 300, such as greater than 500, including 800 to 3000. For example, the dry reducing atmosphere may comprise hydrogen provided from a hydrogen gas tank. Such hydrogen typically contains one molecule of water vapor for about 1000 molecules of hydrogen (i.e., a pH₂/pH₂O ratio of about 1000). In one embodiment, no water vapor is provided into the furnace during the sintering at the first temperature.

The sintering may occur for a time period sufficient to sinter (e.g., fuse) the metal particles in the interconnect. In some embodiments, the interconnect may be sintered for from 3 to 6 hours, such as from 4 to 5 hours. The sintered interconnect contains microstructural porosity.

In step 320, the sintered interconnect is oxidized in an oxidizing atmosphere. As used herein, an “oxidizing atmosphere” comprises an atmosphere at which the metal oxide form of the interconnect rather than the metal form of the interconnect is stable at the oxidizing temperature. For example, the oxidizing temperature may be 700° C. to 1600° C., such as 1350° C. to 1550° C. for interconnects that comprise a chromium based alloy, such as chromium containing 4 to 6 weight percent iron. Below 700° C., the oxidation reaction kinetics are slow, which leads to an undesirable increase in oxidation time. Above 1600° C., chromium begins to evaporate from the interconnect. Chromium oxide (e.g., Cr₂O₃) is stable at the above oxidizing temperatures even in atmospheres which contain both a reducing gas (e.g., hydrogen, ammonia or carbon monoxide) and a sufficient amount of oxidant, such as water vapor, oxygen or carbon dioxide to oxidize the interconnect. Therefore, as used herein, the term oxidizing atmosphere includes a pure oxidizing atmosphere, an atmosphere containing both an oxidant vapor or gas, and a reducing gas. Therefore, if the furnace comprises a vacuum furnace, then the oxidizing atmosphere may comprise a relatively small amount of oxidant introduced into the vacuum atmosphere because chromium oxide (or a combination of chromium oxide and iron oxide) is stable in the oxidizing temperature range.

In one embodiment, the oxidation of a chromium alloy interconnect may be conducted at a lower temperature than the sintering temperature. Therefore, in this embodiment, the temperature of the furnace may optionally be reduced to a second temperature of less than 1300° C., such as a temperature ranging from 950° C. to 1250° C., such as from 1000° C. to 1100° C., or about 1050° C. In some embodiments, the temperature of the furnace may be decreased at a rate of from 100° C./hour to 200° C./hour, such as from 125° C./hour to 175° C./hour. However, any suitable temperature ramp down rate may be used. Alternatively, the temperature of the furnace may be maintained at the sintering temperature, such that the second temperature is the same as the first temperature.

In step 320, an oxidant, such as water vapor may be provided into the furnace. For example, the reducing gas supplied to the furnace may be humidified prior to being supplied to the furnace. In one embodiment, a hydrogen reducing gas may flowed through the humidifier and the humidifier line prior to being flowed into the furnace. The humidifier temperature and the humidifier line temperature may be increased from a temperature below 50° C. (e.g., between 25 and 40° C.) to a temperature above 50° C., such as a temperature ranging from 55° C. to 70° C. when water vapor is provided into the furnace. Alternatively, the water vapor may be provided into the furnace from a separate water vapor generator rather than being mixed into the reducing gas using a humidifier. A ratio of reducing gas (e.g., hydrogen) partial pressure to water vapor partial pressure in the furnace in step 306 during the first period may be less than 300, and may range from 5 to 100, such as from 8 to 20, for example, from 9 to 11, or about 10. Thus, as used herein, an oxidizing atmosphere may include a humidified hydrogen atmosphere (i.e., which contains more hydrogen than water vapor) since chromium oxide rather than chromium is stable at the oxidizing temperature in an atmosphere which contains more hydrogen than water vapor, but a sufficient amount of water vapor to oxidize the interconnect.

Thus, in one embodiment, a ratio of hydrogen partial pressure to water vapor partial pressure in the humidified atmosphere in the furnace during the oxidation step 320 is less than the ratio of the hydrogen partial pressure to water vapor partial pressure in the reducing atmosphere in the furnace during the sintering step 310. It should be noted that controlling the hydrogen to water vapor partial pressure is one way to control the oxygen partial pressure in the furnace. However, other methods may also be used instead or in addition. Furthermore, other oxidants, such as oxygen gas or carbon dioxide gas, may be used instead of or in addition to water vapor.

The furnace may be held at the second temperature for a second period sufficient to sufficiently oxidize the interconnect. In particular, the water vapor may react with the interconnect to generate one or more metal oxides within the pores of the interconnect. For example, the water vapor may oxidize the chromium in the interconnect to form chromium oxide. Optionally, the iron in the interconnect may also be oxidized to form iron oxide. The chromium oxide and optionally iron oxide decrease the porosity and increase the density of the interconnect. In some embodiments, the interconnect may be oxidized for the second period of time ranging from 3 to 6 hours, such as from 4 to 5 hours. However, the oxidation time may vary based on the features of a particular interconnect. After the second period, the water vapor flow into the furnace may be terminated and the humidifier temperature and the humidifier line temperature may be reduced to below 50° C. (e.g., between 25 and 40° C.).

In step 322, the temperature of the furnace may be reduced from the second temperature to a temperature of about 100° C. or less, such as about ambient temperature, and the interconnect may be removed from the furnace. The temperature of the furnace may be reduced at a rate of from 150° C./hour to 350° C./hour, such as from 200° C./hour to 300° C./hour. However, any suitable temperature ramp down rate may be used.

During step 322, the reducing gas flow into the furnace may be terminated when the furnace reaches a temperature of about 600° C. or less, such as a temperature ranging from 600° C. to 400° C., or about 500° C. The inert gas flow is either continued (if present during the second period) or initiated once the reducing gas flow is terminated. The inert gas flow may be provided to improve the safety of the process.

Optionally, water vapor may be provided into the furnace during termination of reducing gas flow into the furnace and initiation of the inert gas flow during step 322. For example, the reducing gas and/or the inert gas may be flowed through the humidifier and the humidifier line to introduce water vapor into the furnace or water vapor may be provided into the furnace from a water vapor generator. The humidifier temperature and the humidifier line temperature may be increased from a temperature below 50° C. (e.g., between 25 and 40° C.) to a temperature above 50° C., such as a temperature ranging from 55° C. to 70° C. when water vapor is provided into the furnace. For example, water vapor may be provided into the furnace for a third period ranging from 10 minutes to 60 minutes, such as from 20 to 40 minutes, during which period the reducing gas flow into the furnace is terminated and the flow of the inert gas is either initiated or continues. The furnace temperature may range from 400° C. to 600° C. during the third period. The water vapor flow into the furnace may be terminated after the third period. A ratio of reducing gas (e.g., hydrogen) partial pressure to water vapor partial pressure in the furnace during the third period may range from 5 to 30, such as from 8 to 20, for example, from 9 to 11, or about 10. Alternatively, water vapor provision into the furnace during the third period may be omitted. The entire interconnect sintering and oxidation in the same furnace may take from 20 to 25 hours, such as about 22 hours.

In step 330, the sintered and oxidized interconnect is removed from the furnace. In one embodiment, the sintered and oxidized interconnect may be removed from the furnace when the furnace reaches ambient temperature (e.g., about 20° C.).

The method may optionally include step 322. In optional step 322, the metal oxide (e.g., chromium oxide) surface layer may be removed from the surface of the interconnect, by a grit blasting process or any other suitable removal process. However, the metal oxide remains in the pores in the interior of the interconnect to decrease the porosity of the interconnect.

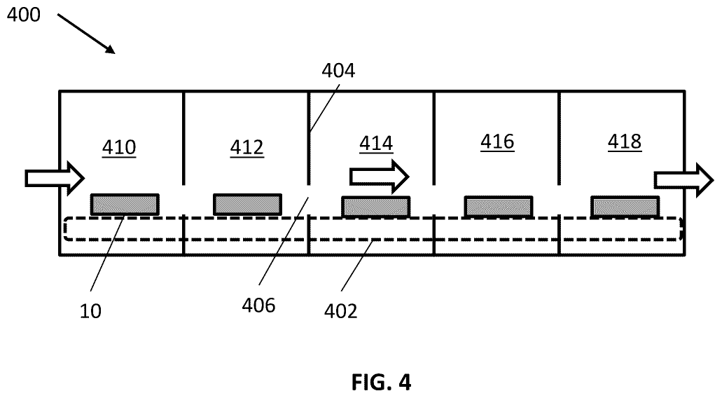

In other embodiments, the sintering and oxidation process may alternatively utilize a continuous furnace rather than a batch furnace as described above. FIG. 4 is a schematic view showing the use of a continuous furnace 400 for sintering and oxidation of interconnects 10, according to various embodiments of the present disclosure. Referring to FIG. 4, the continuous furnace 400 may include zones or chambers having different temperatures and/or atmospheres and may include a support 402 which conveys one or more interconnects 10 through the zones to sinter and oxidize the interconnect. In one embodiment, the support 402 may comprise a ceramic interconnect carrier which is moved through the furnace 400 using a ceramic or high temperature metal push rod. In another embodiment, the support 402 may comprise a high temperature conveyor. Partitions 404 may be provided between the adjacent zones. The partitions 404 may include openings or load locks 406 that permit the interconnects to be conveyed through the partitions 404 on the support 402.

For example, the furnace 400 may include a sintering zone 412 and an oxidation zone 416. The furnace 400 may also optionally include a first transition zone 410 between the entrance and the sintering zone 412, a second transition zone 414 between the sintering and oxidation zones, and a third transition zone 418 between the oxidation zone 416 and the exit. The different zones may be isolated from each other by load lock mechanisms and/or pressure differentials (e.g., zones 410, 414 and 418 may be maintained at a higher pressure than zones 412 and 416 so that process gasses in zones 412 and 416 do not enter the transition zones).

The sintering zone 412 may be maintained at the relatively high first temperature and may include the dry reducing atmosphere. The oxidation zone 416 may be maintained at the second temperature and may include the humidified (i.e., moist) atmosphere.

Referring to FIGS. 3A and 4, the interconnect may be placed into the first transition zone 410 of the furnace 400 in step 300. Step 302 may include heating an interconnect 10 from ambient temperature to the sintering (i.e., first) temperature while the interconnect 10 is in the first transition zone 410. As the interconnect 10 is heated, it may optionally be dewaxed in step 304, and the atmosphere in the first transition zone 410 may optionally be changed in step 306 from the inert atmosphere to the dry reducing atmosphere as the interconnect is heated. Alternatively, the first transition zone 410 may be maintained in the inert atmosphere, and the sintering zone 412 may be maintained in the dry reducing atmosphere.

In step 310, the interconnect 10 may be provided into the sintering zone 412 and heated in the dry reducing atmosphere for a time period sufficient to sufficiently sinter the interconnect 10. The interconnect 10 may then be moved to the second transition zone 414. The temperature of the interconnect 10 may optionally be reduced from the first temperature to the second temperature while the interconnect 10 is moved through in the second transition zone 414 in the dry reducing atmosphere.

The interconnect 10 is then provided from the second transition zone 414 into the oxidation zone 416 that is maintained at the second temperature and that includes the humidified atmosphere. In step 320, the interconnect 10 may remain in the oxidation zone 416 for a time period sufficient to sufficiently oxidize the interconnect 10. The interconnect 10 may then be moved from the oxidation zone 416 into the third transition zone 418.

Step 322 may include reducing the temperature of the interconnect 10 from the second temperature to a temperature of less than about 200° C., while the interconnect 10 is moved through the third transition zone 418. In some embodiments, the atmosphere in the third transition 418 may be changed to the inert atmosphere as the interconnect 10 cools. The interconnect 10 is removed from the furnace 400 in step 330. Step 332 may be performed after removing the interconnect 10 from the furnace 400.

According to a non-limiting example of the present disclosure, PM interconnect material coupons were sintered and oxidized using a batch furnace method as shown in FIG. 3B. A 24-hour die penetration test was conducted to determine whether the coupons were impermeable to gas flow and no leaks were detected. The lack of leaks demonstrated that the oxidation process successfully filled pores and sufficiently increased the density of the coupons to form an oxidized, gas impermeable interconnect in a single furnace.

Accordingly, the disclosed sintering and oxidation process forms gas impermeable interconnects using a single furnace. As such, the disclosed methods beneficially reduce interconnect manufacturing time and cost by utilizing a single furnace for both sintering and oxidation.

The fuel cell and electrolyzer cell stacks of various embodiments of the present disclosure provide a benefit to the climate by reducing greenhouse gas emissions.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A method, comprising:
placing an interconnect in a furnace;
sintering the interconnect by heating the interconnect in a reducing atmosphere in the furnace;
oxidizing the interconnect by heating the interconnect in an oxidizing atmosphere in the furnace; and
removing interconnect from the furnace.

2. The method of claim 1, wherein the reducing atmosphere comprises a hydrogen atmosphere, and wherein the oxidizing atmosphere comprises a hydrogen and water vapor atmosphere.

3. The method of claim 2, further comprising:
flowing a hydrogen gas directly to an interior volume of the furnace to form the reducing atmosphere comprising hydrogen in the furnace; and
flowing the hydrogen gas through an external humidifier and a humidifier line prior to flowing the hydrogen gas to the interior volume of the furnace to form the oxidizing atmosphere comprising a hydrogen and water vapor atmosphere in the furnace.

4. The method of claim 3, wherein a ratio of hydrogen partial pressure to water vapor partial pressure in the oxidizing atmosphere in the furnace is less than the ratio of the hydrogen partial pressure to water vapor partial pressure in the reducing atmosphere in the furnace.

5. The method of claim 4, wherein the ratio of hydrogen partial pressure to water vapor partial pressure in the humidified atmosphere in the furnace is less than 300, and the ratio of the hydrogen partial pressure to water vapor partial pressure in the reducing atmosphere in the furnace is greater than 300.

6. The method of claim 5, further comprising increasing a temperature of the humidifier and the humidifier line when the water vapor is provided into the furnace.

7. The method of claim 1, wherein:
the sintering the interconnect comprises heating the interconnect in the reducing atmosphere at a first temperature between 700° C. and 1600° C.; and
the oxidizing the interconnect comprises heating the interconnect in the oxidizing atmosphere at a second temperature between 700° C. and 1600° C.

8. The method of claim 7, wherein:
the first temperature ranges from 1350° C. to 1550° C.; and
the second temperature ranges from 950° C. to 1150° C.

9. The method of claim 7, further comprising:
flowing an inert gas into the furnace until the furnace reaches a temperature of at least 400° C. prior to the sintering the interconnect; and
initiating a flow of reducing gas into the furnace after the furnace reaches the temperature of at least 400° C. and before the sintering the interconnect.

10. The method of claim 9, further comprising initiating a flow of water vapor into the furnace such that the water vapor flows into the furnace during the initiating the flow of the reducing gas, and terminating the flow of water vapor into the furnace prior to the sintering the interconnect.

11. The method of claim 9, further comprising:
continuing flowing the reducing gas into the furnace during the sintering the interconnect and the oxidizing the interconnect until the furnace temperature is decreased to at least 600° C. after the oxidizing the interconnect; and
terminating the flow of the reducing gas.

12. The method of claim 11, further comprising initiating a flow of water vapor into the furnace such that the water vapor flows into the furnace during the terminating the flow of the reducing gas, and terminating the flow of the water vapor into the furnace prior to the removing the interconnect from the furnace.

13. The method of claim 11, further comprising flowing the inert gas into the furnace through a humidifier during and after the terminating the flow of the reducing gas.

14. The method of claim 1, further comprising forming the interconnect by compressing a mixture of a lubricant and a metal powder comprising from about 4 wt. % to about 6 wt. % percent iron, 0-1 wt. % yttrium, and balance chromium, prior to the placing the interconnect in the furnace.

15. The method of claim 1, further comprising removing a metal oxide surface layer on a surface of the interconnect after removing the interconnect from the furnace.

16. The method of claim 1, further comprising placing the interconnect into an electrochemical cell stack comprising fuel cells or electrolyzer cells after the removing interconnect from the furnace.

17. The method of claim 1, wherein the furnace comprises a batch furnace.

18. The method of claim 1, wherein the furnace is a continuous furnace.

19. The method of claim 18, wherein the sintering the interconnect occurs in a sintering zone of the furnace, and the oxidizing the interconnect occurs in an oxidation zone of the furnace separate from the sintering zone.

20. The method of claim 19, further comprising:
providing the interconnect into a first transition zone of the furnace and increasing a temperature of the interconnect;
providing the interconnect from the first transition zone into the sintering zone;
providing the interconnect from the sintering zone into a second transition zone and decreasing the temperature of the interconnect; and
providing the interconnect from the oxidation zone into a third transition zone and decreasing the temperature of the interconnect prior to the removing the interconnect from the furnace.
